(19) United States
(12) Patent Application Publication
(10) Pub. No.: US 2022/0039444 A1
(43) Pub. Date: Feb. 10, 2022

(54) Viscous Sauce Suitable For Pressure Cooker

(71) Applicant: Kraft Foods Group Brands LLC, Chicago, IL (US)

(72) Inventors: Travis A. Larson, Glenview, IL (US); Andrew McPherson, Mount Prospect, IL (US); John B. Topinka, Evanston, IL (US); Katherine Ann Peterson, Arlington Heights, IL (US); Gavin M. Schmidt, Hoffman Estates, IL (US); Cosmin Beliciu, Ithaca, NY (US); Michael Howeler, Ithaca, NY (US); Michael Andrews, Ithaca, NY (US)

(21) Appl. No.: 16/985,899

(22) Filed: Aug. 5, 2020

(51) Int. Cl. A23L 23/00; A23L 29/219; A23L 29/262; A23L 5/10

(52) U.S. Cl. CPC A23L 23/00; A23L 29/219; A47J 27/092; A23L 5/13; A23V 2002/00; A23L 29/262

(57) ABSTRACT

A viscous sauce suitable for use in a multifunction pressure cooker is provided. The sauce comprises a starch, a low temperature viscosity agent, and a high temperature viscosity agent. The sauce provides desirable viscosity at ambient temperature and after cooking in a pressure cooker. A method of preparing the viscous sauce is also provided. A method of preparing a preparing a meal in a pressure cooker utilizing the viscous sauce is also provided.

### FIELD

The application relates generally to a sauce suitable for use in a multifunction pressure cooker while providing desirable viscosity before and after cooking.

### BACKGROUND

There has been increased consumer demand for food products and kitchen appliances to prepare satisfying and healthy meals at home with reduced cooking effort. Though pressure cookers have been sold for decades, multifunction pressure cookers, such as the Instant Pot®, have enjoyed significant interest from consumers in recent years. Pressure cookers, in particular, have enabled consumers to prepare a diverse range of meals faster than with conventional cooking methods.

A variety of food products have been marketed for use in instant pots. For example, frozen meal kits are designed and sold for use in pressure cookers. Products range from soups and stews, pasta, and rice dishes. The kits may also include meat, such as beef, chicken, pork, or turkey.

Multifunction pressure cookers typically include a heat source beneath a receptacle or pot. A lid is sealed on the receptacle to restrict escape of water vapor or other fluids, such that outflow of fluids can occur only through one or more pressure relief valves. This enables elevated internal pressures to be maintained during heating operations and can enable cooking times and moisture loss to be reduced.

When a frozen food item is heated in a pressure cooker with the bottom surface resting on a heated bottom surface of the pressure cooker interior, initial heating may result in a localized phase change, creating a thin layer of liquid at the bottom of the food item. The liquid layer may incorporate particulate or other solid matter. The vertical dimension of the liquid layer may increase progressively as heating continues, but localized overheating may nevertheless occur, e.g., where solid components of the food item directly contact the heated bottom of the receptacle, depending on factors such as the heat transfer characteristics of the cooker, local temperatures at various points on the interior surface of the cooker at various times during the process, the content and viscosity of the liquid layer, the nature and content of solid components of the food product, and the length of time during which the heating element is operated.

Problems such as burning, scorching, overcooking, uneven heating, toughening, excessive drying, and/or other problems can present difficult challenges under certain circumstances, particularly where frozen food products are involved. Such problems can be difficult to address in pressure cookers due to the cooker remaining closed during heating processes, such that food items in the cooker may be relatively static, with little or no movement other than flow associated with natural convection resulting from heat transfer to the food items, i.e., without any opportunity for a user to stir or otherwise displace the food items with a utensil. In some cases, adding water to the receptacle may help to alleviate such problems. However, addition of water and use of trivets tends to slow the rate of cooking or heating. Also, addition of water or use of trivets does not always avoid burning, scorching, etc., and for some food items, addition of water may have an undesirable effect on organoleptic properties of the food item.

It would be beneficial to provide additional food products suitable for consumers to cook in a pressure cooker.

### DETAILED DESCRIPTION

Provided herein are viscous sauces formulated for cooking in a pressure cooker. Formulating a sauce for use in a pressure cooker presents numerous challenges. First, because the pressure cooker is a closed system, any moisture from other food ingredients in the cooker (e.g., meat and/or vegetables) can leach into the sauce and create an undesirably thin consistency. Second, the high temperature and pressure reached in the cooker can damage certain ingredients, such as texturants and/or viscosity increasing agents. For instance, starch granules may be damaged during the cooking process and may not be effective to provide an intended higher viscosity in the cooked product. When this occurs, the viscosity of the sauce might be a desirable pourable viscosity out of the jar but may be undesirably thin after cooking. Third, texturants and/or viscosity increasing agents might activate too early, such as during production of the sauce, thereby creating an overly viscous product that is not readily pourable from a jar by the consumer. The sauces described herein are advantageously formulated to address these problems.

The viscous sauces described herein have a desirable thick viscosity both before and after cooking in a pressure cooker (i.e., a desirable “hot” viscosity). The sauces also have a good body and mouthfeel after cooking. The viscous sauces further provide for good “cling” to meat and vegetables cooked in the pressure cooker or that are combined with the sauce after the sauce is cooked in the pressure cooker. In another aspect, the sauces are formulated to substantially avoid problems such as burning or scorching in the pressure cooker.

One prior attempt to address the issue of low viscosity sauce after cooking was to utilize the “sauté” function of certain pressure cookers, such as the Instant Pot®. The “sauté” function is used to reduce the moisture of the ingredients in the pressure cooker by about 50 percent, thereby significantly increasing the viscosity of the sauce. However, adding further steps and time to the cooking process is less convenient for consumers. Therefore, at least in some approaches the sauces described herein can be cooked in the pressure cooker without requiring a further step specifically carried out to reduce the moisture content of the sauce.

In one approach, the sauce is a “starter” sauce, which means that it is expected that the consumer will combine the sauce with additional components, such as a farinaceous component, fruit component, vegetable component, and/or protein component, to create a meal. The further components may be added to the sauce in the pressure cooker before cooking or can be combined with the sauce after the sauce has been cooked in the pressure cooker. The sauce may also be formulated for the consumer to add additional components, such as water, oil (e.g., soybean oil, olive oil, canola oil, coconut oil, grapeseed oil, safflower oil, etc.), to the pressure cooker.

The sauce can be provided in a variety of types, such as a braising sauce, a marinara sauce, a Bolognese sauce, a sweet and sour sauce, a barbeque sauce, a gravy, a tartar sauce, a mushroom sauce, a pesto sauce, a chipotle sauce, a cream sauce, a fajita sauce, and a teriyaki sauce. In some examples, the marinara sauce may include one or more of tomatoes, garlic, and onions. In some examples, the sweet and sour sauce may include one or more of pineapple juice, sugar, vinegar, tomato sauce, ketchup, and thickener (e.g., cornstarch, tapioca starch, etc.). In some examples, the barbeque sauce may include sweetener (e.g., brown sugar, honey, molasses, or any combination thereof), ketchup, vinegar (e.g., apple cider vinegar, red wine vinegar, rice vinegar, or combination thereof), and Worcestershire. In some examples, the gravy may include one or more of meat juice, butter, flour, and stock. In some examples, the tartar sauce may include one or more of mayonnaise, onion, pickle relish, and lemon juice. The sauces may also include one or more of herbs, salt, pepper, and spices to provide the desired flavor profile.

At least in some approaches, the sauce is a shelf-stable sauce, meaning that the sauce can be stored in a sealed jar at ambient conditions (e.g., about 70 to about 75° F.) for at least about 6 months, in another aspect at least about 7 months, and in another aspect at least about 8 months, without resulting in spoilage or microbial growth.

To achieve shelf-stability, the sauces generally need to have a pH of less than about 4.1, in another aspect less than about 4.0. A food grade acid may be added to the sauce to achieve the desired pH if the ingredients for the sauce do not otherwise provide the desired low pH. Suitable food grade acids include, for example, glucona delta lactone, malic acid, gluconic acid, lactic acid, phosphoric acid, citric acid, and propionic acid. For example, the acid may be included in the form of another food ingredient, such as vinegar or a citrus juice.

To prepare a shelf-stable sauce, the sauce may be cooked at a temperature of about 195 to about 205° F. for about 15 to about 30 seconds. The sauce may then be hot-filled into jars, cans, or other containers.

It has been found that a combination of ingredients is necessary to achieve the various benefits described herein. The sauce includes, in pertinent part, water, starch, a first viscosity increasing agent, and a second viscosity increasing agent. In some approaches, the sauce may further include soluble fiber, as discussed in more detail below.

Exemplary starch ingredients include modified starches. Such modifications generally include acid modifications or enzyme modifications. For example, suitable starches include granular cookup starches, crosslinked starches, substituted starches, and starches that are both crosslinked and substituted. In one approach, a crosslinked modified starch is used, such as TENDERFIL® 9, which is a modified (hydroxypropyl) crosslinked tapioca starch Tate & Lyle). Though there may be exceptions, it is generally thought that native starches do not provide sufficient textural and viscosity benefits during the shelf life of the sauce.

In some embodiments, the sauce includes about 0.5 percent to about 7 percent starch, in another aspect about 2 to about 5 percent, in another aspect about 2.5 to about 3.5 percent.

The first viscosity increasing agent and the second viscosity increasing agent both play different roles in the sauce texture. The first viscosity increasing agent is one that does not substantially hydrate at low temperature (e.g., below about 110° F.). By “substantially hydrate,” it is meant that the first viscosity increasing agent is less than about 20% hydrated, in another aspect less than about 10% hydrated, in an aqueous liquid at a temperature below about 110° F. In one approach, starch hydration can be measured via change in viscosity of the starch, such as using a Brookfield viscometer. By selecting such a first viscosity increasing agent, the first viscosity increasing agent provides little to no viscosity benefit to the sauce during much of the production process prior to final heating steps. Particularly suitable first viscosity increasing agents are able to fully hydrate and provide increased viscosity in an aqueous solution) at high temperature (e.g., above about 160° F.) and revert back to liquid when cooled (e.g., below about 110° F.). Accordingly, a suitable first viscosity increasing agent may also be referred to as a “high temperature viscosity agent.”

Instead, appropriate first viscosity increasing agents will provide significant viscosity increases at high temperature, such as after pressure cooking the sauce and during plating and consuming of a meal, but lower viscosity at ambient temperature, such as during the shelf life of the sauce. This allows for desirable pourability from a jar or other container. Exemplary first viscosity increasing agent include hydroxypropyl methylcellulose (PHMC) or methylcellulose (MC). A suitable commercially available product is Methocel™ A4C.

In contrast, exemplary second viscosity increasing agent include those that hydrate in water at low temperature (e.g., under 100° F.) and result in increased viscosity at that low temperature. As with the first viscosity increasing agent, the ability to hydrate at a given temperature can be determined via change in viscosity in an aqueous solution, such as using a Brookfield viscometer. Accordingly, a suitable second viscosity increasing agent may also be referred to as a “low temperature viscosity agent.” In one particular approach, the second viscosity increasing agent comprises a cellulose gum, such as carboxymethylcellulose (such as TIC Ticalose CMC 6000).

It was surprisingly found that a careful selection of both the amounts and ratios of the first and second viscosity increasing agents provided textural and viscosity benefits to both the sauce at ambient temperature (i.e., when in the jar) and at high temperature (i.e., after pressure cooking and at the time of consumption).

In some embodiments, the sauce includes about 0.1 percent to about 1.5 percent high temperature viscosity increasing agent, in another aspect about 0.2 to about 1.3 percent, in another aspect about 0.3 to about 1.2 percent, in another aspect about 0.3 to about 1.0, in another aspect about 0.3 to about 0.9 percent of a high temperature viscosity agent. At the same time, the sauce further includes about 0.05 to about 0.7 percent low temperature viscosity increasing agent, in another aspect about 0.075 to about 0.6 percent, in another aspect about 0.1 to about 0.5, and in another aspect about 0.1 to about 0.4 percent low temperature viscosity increasing agent.

In some embodiments, it has been found to be advantageous that the first viscosity increasing agent and second viscosity increasing agent are included in a ratio of about 1.7:1 to about 2.5:1, in another aspect about 1.8:1 to about 2.3:1, in another aspect about 1.9:1 to about 2.2:1, and in yet another aspect about 1.95:1 to about 2.1:1.

At least in some approaches, it has been found to be advantageous to limit the fat content of the sauce. At least in one embodiment, the sauce is not in the form of a water-in-oil emulsion. In a further respect, the sauce includes less than about 10 percent fat, in another aspect less than about 8 percent fat, in another aspect less than about 6 percent fat, in another aspect less than about 4 percent fat, and in another aspect less than about 2 percent fat by weight of the sauce. The total fat content refers to any solid fat or liquid oil contributed by any ingredient in the sauce.

In one approach, the sauce is a tomato-based sauce. In one approach, the sauce may further comprise a tomato component, such as tomato paste, tomato concentrate, or tomato sauce. In this respect, the tomato component may contribute additional fiber to the sauce.

In another approach, the sauce is a dairy sauce. In this approach, the sauce may further comprise a dairy component, such as whole milk, cream, milk protein concentrate, whey protein concentrate, milk fat, or a combination thereof. However, even when a dairy component is included, it has been found to be advantageous to include less than about 10 percent fat, as discussed above.

In some embodiments, it has been found that providing a total solids content of about 20 to about 40 percent, in another aspect about 21 to about 36 percent, is advantageous while limiting sugar content. In some approaches, a significant proportion of the total solids is soluble fiber. In one approach, the sauce includes a soluble fiber content of about 2 to about 18 percent, in another aspect about 3 to about 14.5 percent soluble fiber, and in another aspect about 3.5 to about 12 percent soluble fiber. Along with the high soluble fiber content, the sauce has a total sugar content of less than about 10 percent, in another aspect less than about 7 percent sugar, and in another aspect less than about 4 percent sugar.

Any suitable source of soluble fiber can be used. Commercially available soluble fiber products include, for example, Promitor® 85L (a liquid soluble corn fiber (containing at least 85% dietary fiber) from Ingredion).

The term “sugar” is used herein to refer to any sugar in liquid or solid form, such as fructose, glucose, sucrose, lactose, honey, agave, monosaccharide, disaccharide, and combinations thereof. When limiting the sugar content of the sauce, low caloric or non-nutritive sweeteners may be included, if desired. For example, the sauce may include both low intensity and high intensity sweeteners, such as, for example, sucralose, aspartame, stevia, saccharine, monatin, luo han guo, neotame, sucrose, Rebaudioside A (often referred to as “Reb A”), cyclamates (such as sodium cyclamate), acesulfame potassium, and combinations thereof.

In one embodiment, the sauce can be prepared according to the following method: combine water, high temperature viscosity agent, low temperature viscosity agent, and starch and mix to hydrate the low temperature viscosity agent; add any additional ingredients, including any soluble fiber, to the mixture containing the hydrated low temperature viscosity agent and heat to a temperature effective to hydrate the high temperature viscosity agent and to gelatinize the starch, such as about 150 to about 175° F. for about 15 to about 40 minutes; optionally adjust the pH of the mixture, if needed, to achieve a pH of less than about 4.1; pasteurize the mixture, such as a temperature of about 195° F. to about 205° F. for about 15 seconds to about 30 seconds; and hot fill containers with the mixture. In the present method, high shear is not required for mixing the ingredients. Indeed, it some approaches high shear may be problematic due to damaging one or more of the viscosity agents. In those embodiments, mixing specifically excludes high shear mixing.

Generally, the sauces may be packaged, such as in a glass or plastic jar, can, or other suitable container. It is generally preferred that the sauce be dispensed into the container using a hot-fill process. The sauce is then ready for use at a later date.

In some examples, the sauce has a viscosity within the range of about 6000 centipoise (cP) to about 8500 cP, in another aspect about 6200 cP to about 8300 cP, in another aspect about 6300 cP to about 8000 cP, and in another aspect about 6500 cP to about 7000 cP, when measured at 72° F. using a Brookfield DV3T viscometer using a RV6 spindle, at 30 rotations per minute (RPM).

As noted above, the sauces described herein are particularly suitable for cooking in a pressure cooker, such as a multifunction pressure cooker or a slow cooker, and having desirable thick texture after cooking in the pressure cooker. In some examples, the sauce has a viscosity within the range of about 400 centipoise (cP) to about 1500 cP, in another aspect about 650 cP to about 1200 cP, and in another aspect about 850 cP to about 1100 cP, when measured at 140° F. using a Brookfield DV3T viscometer using a RV2 spindle, at 30 rotations per minute (RPM) after being cooked in the pressure cooker.

Exemplary pressure cookers for cooking the sauces described herein include Instant Pot® Duo 7-in-1 6 quart, Instant Pot® Duo Plus 6 quart, and Instant Pot® Ultra 10-in-16 quart, as well as multifunction pressure cookers sold under brands such as Ninja, Crockpot, and Cooks Essential.

In some embodiments, a pressure cooker may comprise a removable pot. In some embodiments, a multifunction pressure cooker comprises a heating element beneath a pot that has a cavity for receiving food items to be heated. In some embodiments, multifunction pressure cookers include 6-12 different functions. Exemplary heating functions of multifunction pressure cookers may include one or more of a pressure cooking function, bean heating function, a broth heating function, a cake preparing function, a chili heating function, a custom function, an egg heating function, a meat heating function, a multigrain heating function, a porridge heating function, a rice heating function, a sauté function, a searing function, a slow cook function, a soup heating function, a steaming function, a stew heating function, a sterilizing function, a warming function, a yogurt function, etc. In one embodiment, the sauce is particularly effective in “pressure cook” mode.

Multifunction pressure cookers can generally operate at various pressures and temperatures for cooking or heating food items. Exemplary pressures used when heating food under pressure in multifunction pressure cookers range from about 9 to about 13 psi, about 9.5 to about 12.5 psi, about 10 to about 12 psi, or about 10.2 to about 11.6 psi. Exemplary temperatures for heating food under pressure in multifunction pressure cookers range from about 220 to about 260° F., about 225 to about 255° F., about 230 to about 250° F., about 240 to about 250° F., about 235 to about 245° F., or about 239 to about 244° F.

When cooked by the consumer, one exemplary method for preparing a meal in a pressure cooker, such as an Instant Pot®, using the sauces described herein comprises: optionally heating oil, for example using a “sauté” setting on high heat; optionally adding a desired protein component for about five minutes with stirring; adding about 0.5 cup to about 1.5 cups water, in another aspect about 0.5 to about 1.1 cups water, in another aspect about 0.5 cup to about 0.66 cup water, to the pressure cooker; adding a sauce described herein to the pressure cooker; closing and locking lid of pressure cooker; turning pressure release valve to sealing position; and cooking for about 4 to about 8 minutes, in another aspect about 5 to about 7 minutes, such as using “high pressure cook/manual” setting; and releasing pressure before opening lid. The sauce may then be served with other food components, such as a vegetable component and/or a farinaceous component.

Exemplary protein components include chicken, beef, pork, finfish, shellfish, plant-based protein sources, and any combinations thereof. Chicken may include drumstick, wing, thigh and/or breast meat. Beef may include chuck, shank, brisket, short plate, flank, loin, sirloin, the round, and/or rib meat. Pork may include shoulder, loin, belly, and/or leg meat. Finfish may be tilapia, salmon, cod, haddock, tuna, flounder, halibut, catfish, snapper, whiting, ocean perch, grouper, seabass, redfish, whitefish, pollock, etc. Shellfish may be shrimp, crayfish, crab, lobster, clams, scallops, oysters, mussels, etc. Plant-based protein sources include beans (e.g., chickpeas, black beans, navy beans, kidney beans, cannellini beans, pinto beans, great northern beans), edamame, tofu, seitan, textured vegetable protein, tempeh, and the like, as well as plant-based versions of hot dogs, sausages, burgers, cutlets, patties, roasts, etc.

Exemplary farinaceous components include potatoes, pasta, rice, bread, and combinations thereof. Potatoes may include red bliss, russets, Yukon gold, la ratte, kennebec, cranberry red, all blue, red thumb, Russian banana, German butterball, purple majesty, rounded red potatoes, sweet potatoes, etc. Pasta may include fettuccine, orecchiette, tortellini, linguine, farfalle (also referred to as bowtie), rigatoni, penne, ziti, ravioli, fusilli, conchiglie (also referred to as shells), macaroni, gemelli, rice noodles, Lo Mein noodles, etc. Rice may include brown rice, jasmine rice, wild rice, basmati, black rice, white rice, egg fried rice, etc. Bread may include white bread, French bread, naan, biscuits, cornbread, cheese and garlic bread, rolls, etc.

Exemplary vegetable components include broccoli, green beans, asparagus, corn, carrots, tomatoes, peppers, pumpkin, squash, peas, beans, eggplant, kale, mustard greens, zucchini, cauliflower, Brussel sprouts, and any combination thereof.

To further illustrate the present disclosure, examples are given herein. It is to be understood that these examples are provided for illustrative purposes and are not to be construed as limiting the scope of the present disclosure.

### EXAMPLES

### Example 1

Sauces were initially prepared by varying the starch ingredient. Rezista® 682 (Tate & Lyle), Rezista® FIV (Tate & Lyle), Shur-Fil® (Tate & Lyle), and MaxiGel® (Tate & Lyle) were used. The sauces were prepared and heated to a temperature of between about 150° F. to about 175° F. for about 15 to about 40 minutes and then a pasteurization step of about 195° F. to about 205° F. for about 15 to about 30 seconds. The starches appeared to remain functional after the heating step in the production process but were very thin at a temperature of about 170° F. after cooking in an Instant Pot® cooker. These results indicated that starches alone were ineffective to provide desired viscosity both at ambient temperature and after cooking in a pressure cooker. The thin sauces also did not stabilize the fat from meat cooked with the sauce, and the fat quickly separated at the top of the sauce and was not visually appealing.

### Example 2

A teriyaki sauce was prepared using soy protein (Supro EX45, which is advertised as being developed for high gelation capability and good emulsifying capacity). The soy protein did not perform well and resulted in a thin viscosity after cooking in an Instant Pot® cooker. These results demonstrated that not all gelling proteins are capable of providing a desired viscosity increase in a sauce cooked in a pressure cooker.

### Example 3

Other teriyaki sauces were prepared using hydrocolloids, including CESAGUM® LN-3 (locust bean gum; Tate & Lyle), TICACEL® FIV (high viscosity methylcellulose; TIC Gums, Inc.), Ticalose® CMC 6000 (high viscosity fine mesh sodium carboxymethylcellulose derived from cellulose; TIC Gums, Inc.) and Ticalose® CMC 15000 (high viscosity CMC powder; TIC Gums, Inc.), and COLFLO® 67 (modified starch derived from waxy maize; Ingredion) used with Keltrol RD (14-mesh agglomerated food grade xanthan gum; CPKelco).

Favorable results were obtained using 1% Ticalose® CMC 6000 powder. It was found that this carboxymethylcellulose provided good pourability from the jar, as well as good thickness, mouthfeel, and flavor release.

It was further found that including Tenderfil® 9 (Tate & Lyle) in combination with the Ticalose® CMC 6000 further improved the texture of the sauce. The combination also provided significantly better cling when the cooked sauce was combined with rice and broccoli. In contrast, a sauce made with combination of COLFLO® 67 starch and Keltrol RD xanthan gum showed low cling and dripped to the bottom of the plate from the rice and broccoli.

### Example 4

Additional sauces were prepared to evaluate additional thickeners. Four different Teriyaki sauces were developed to test use of Methocel and Rezista starch with the Tenderfil® 9 starch and Ticalose® CMC 6000. These formulations were prepared with combinations of CMC and Methocel or blends of Tenderfil® and Rezista starch. In the CMC-Methocel variables, two-thirds of the initial CMC concentrations and different levels of Methocel were used. Methocel does not provide cold viscosity, so the initial slurry viscosity was much thinner. The four formulations are shown in Table 1 below.

TABLE 1
Variables

| | |
|---|---|
| Sample A | 3% Tenderfil starch + 0.2% CMC + 0.4% Methocel |
| Sample B | 1.5% Tenderfil starch + 1% Rezista starch + 0.3% CMC |
| Sample C | 2% Rezista + 0.3% CMC |
| Sample D | 1.5% Tenderfil starch + 1% Rezista starch + 0.2% CMC + |
| | 0.4% Methocel |

The sauces were produced using a medium to high shear approach: soy sauce, water, ginger, and sucralose were blended with the Methocel and/or carboxymethylcellulose for 5 minutes at medium speed in a Warring blender. The slurry temperature after this step was 130° F.-132° F. The starch (Tenderfil and/or Rezista) was then added and the slurry was blended in the Warring blender for an additional 2.5 minutes. The final temperature of the slurry was between 151-155° F. The finished sauces were then produced by adding the balance of ingredients to a Kenwood mixer, adding the pre-sheared slurry, and heating to 195° F. before hot filling in jars.

The sauces were then cooked in a 6-quart Instant Pot® (without meat) by adding 1 tablespoon of oil, ½ cup of water, and 450 g of sauce and cooked for 8 minutes on “manual” setting. After cooking, the hot sauces were collected in a mason jar, capped, and equilibrated in a water bath at 60° C. before testing for viscosity using a Brookfield DV3T viscometer with a RV2 spindle, at 30 rotations per minute (RPM).

TABLE 2

| | Viscosity of the gum | Viscosity of the post-Instant |
|---|---|---|
| Sample | and starch slurry, cP | Pot ® sauce, no chicken, cP |
| Sample A | 684 @ 53° C. | 2,517 @ 63° C. |
| Sample B | 11,050 @ 51° C. | 730 @ 65° C. |
| Sample C | 20,000 @ 57° C. | 2,960 @ 59° C. |
| Sample D | 836 @ 53° C. | 1,263 @ 67° C. |

Samples B and C, especially Sample C, were very thick upon initial mixing. The post-cook Sample C was thick, but the volume of sauce recovered from the Instant Pot® was significantly lower than the other sauces (by about a third). The best performing sauces were Samples A and Sample D, with good initial mixing viscosity and thick post-cook viscosities.

For confirmation of performance, the two best sauces were cooked with 1.5 pounds of ¾″ cubed chicken thighs plus 16 ounces of sauce in an Instant Pot® pressure cooker. The meat was first browned with 1 tablespoon oil for about 5 minutes. Then ½ cup water was added to deglaze the pot. The sauce was then poured into the center of the pot with no mixing. The pot was closed, and the meal cooked on “manual” setting for 8 minutes.

Sample A had a viscosity of 769 cP, while Sample D had a much lower viscosity of 276. These results demonstrated that the usage of higher resistant starch content in Sample D was not beneficial for providing the high viscosity desired in the cooked sauce. It was concluded that the combination of starch and carboxymethylcellulose provided a good, pourable viscosity at lower temperature and the methylcellulose contributed to a good hot viscosity after cooking.

Taking into account the results from Sample A, additional sauce formulations were prepared according to Table 3 below:

TABLE 3

| | Lemon | | Chipotle | |
|---|---|---|---|---|
| | Herb | BBQ | Lime | Teriyaki |
| | Sauce | Sauce | Sauce | Sauce |
| Tenderfil ® 9 | 3.9% | 3.1% | 3.5% | 3.0% |
| Promitor ® 85 L | 15.5% | 3.1% | 3.1% | 13.5% |
| Ticalose ® CMC 6000 | 0.27% | 0.174% | 0.39% | 0.19% |
| Methocel ® A4C | 0.55% | 0.36% | 0.81% | 0.4% |
| Water (tap) | 50.8% | 47.8% | 64.3% | 20.4% |
| Salt | 1.2% | 1.5% | 0.9% | — |
| Tomato paste | — | 20.2% | 9.7% | 9.3% |
| Sugar (granulated) | 3.4% | — | — | |
| Brown sugar | — | 4.5% | — | |
| Molasses | — | 5.6% | — | |
| (blackstrap) | | | | |
| Honey | — | — | 6.0% | 6.0% |
| Broth | 0.4% | — | 0.45% | |
| Heavy cream | 17.2% | — | — | |
| Sucralose | — | 0.04% | — | 0.006% |
| Vinegar (white | — | 11.2% | — | 2.1% |
| distilled) | | | | |
| Soy sauce (low | — | — | — | 18.9% |
| sodium) | | | | |
| Minced garlic | 4.0% | — | 2.5% | 2.4% |
| Citrus juice | 2.0% | — | 1.2% | |
| concentrate (lemon | | | | |
| and/or lime) | | | | |
| Pineapple juice | — | — | — | 5.0% |
| concentrate | | | | |
| Chipotle peppers in | — | — | 6.7% | |
| adobo | | | | |
| Chopped yellow | — | — | — | 18.5% |
| onion | | | | |
| Herbs/spices/ | 0.78% | 2.426% | 0.45% | 0.3% |
| pepper/flavors | | | | |
| Total | 100% | 100% | 100% | 100% |

In the above formulations, the Methocel was included by multiplying by a factor of 2.075 of the amount of Ticalose CMC. The resulting sauces were cooked in an Instant Pot® (without meat). The viscosities were measured according to the method described above in Example 4. The viscosities were as follows: 726 cP for the Lemon Herb sauce, 945 cP for the BBQ sauce, and 819 cP for the Chipotle Lime sauce. These sauces had good viscosity and texture during consumption.

All percentages and ratios are calculated by weight unless otherwise indicated. All percentages and ratios are calculated based on the total weight of the compound or composition unless otherwise indicated.

Reference throughout the specification to “an example,” “one example,” “another example,” “some examples,” “other examples,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A viscous sauce suitable for cooking in a pressure cooker, the sauce comprising:
a protein content of 0 percent up to about 4 percent;
a fat content of 0 percent up to about 8 percent;
about 30 percent to about 75 percent water;
about 0.1 percent to about 1.5 percent of a high temperature viscosity agent;
about 0.05 percent to about 0.7 percent of a low temperature viscosity agent;
about 0.5 percent to about 7 percent starch; and
wherein the high temperature viscosity agent and the low temperature viscosity agent are included in a ratio of about 1.7:1 to about 2.5:1, and
wherein the sauce has a viscosity between about 6000 cP to about 8500 cP at 72° F. prior to being cooked in a pressure cooker.

2. The viscous sauce according to claim 1, wherein the sauce has a viscosity of about 400 cP to about 1500 cP at a temperature of about 140° F. after being cooked in a pressure cooker.

3. The viscous sauce according to claim 1, wherein the sauce is a pasteurized sauce having a viscosity between about 6200 cP to about 8300 cP at 72° F. prior to being cooked in a pressure cooker.

4. The viscous sauce according to claim 1, further comprising about 2.5 percent to about 18 percent soluble fiber.

5. The viscous sauce according to claim 1, further comprising about 3 percent to about 14.5 percent soluble fiber.

6. The viscous sauce according to claim 1, wherein the high temperature viscosity agent and the low temperature viscosity agent are included in a ratio of about 1.8:1 to about 2.3:1.

7. The viscous sauce according to claim 1, wherein the high temperature viscosity agent and the low temperature viscosity agent are included in a ratio of about 1.9:1 to about 2.2:1.

8. The viscous sauce according to claim 1, wherein the starch is included in a range of about 2 percent to about 5 percent.

9. The viscous sauce according to claim 1, wherein the starch is included in a range of about 2.5 percent to about 3.5 percent.

10. The viscous sauce according to claim 1, wherein the modified starch is a crosslinked starch.

11. The viscous sauce according to claim 1, having a fat content of 0 percent up to about 5 percent.

12. The viscous sauce according to claim 1, having a fat content of 0 percent up to about 3 percent.

13. The viscous sauce according to claim 1, wherein the high temperature viscosity agent comprises methylcellulose.

14. The viscous sauce according to claim 1, wherein the low temperature viscosity agent comprises cellulose gum.

15. The viscous sauce according to claim 1, wherein the low temperature viscosity agent comprises carboxymethylcellulose.

16. A method of preparing a viscous sauce according to claim 1 that is suitable for cooking in a pressure cooker, the method comprising:
combining water, the high temperature viscosity agent, the low temperature viscosity agent, and starch to form a sauce mixture;
mixing to hydrate the low temperature viscosity agent in the sauce mixture;
heating the sauce mixture to a temperature effective to hydrate the high temperature viscosity agent and gelatinize the starch; and
optionally adjusting pH of the sauce mixture to achieve a pH of less than about 4.1.

17. The method of claim 16, further comprising hot filling the sauce mixture into containers.

18. A method of preparing a meal in a pressure cooker, the method comprising:
adding about 0.5 cups to about 1.5 cups water to the pressure cooker;
adding the viscous sauce according to claim 1 to the pressure cooker;
closing and locking lid of pressure cooker;
turning pressure release valve to sealing position; and
cooking the viscous sauce for about 4 to about 8 minutes; and
optionally combining the cooked viscous sauce with one or more other food components.

19. The method according to claim 18, further comprising adding a protein component to the pressure cooker.

20. The method according to claim 18, where the one or more other food components comprises a vegetable component and/or a farinaceous component.
